(19) United States
(12) Patent Application Publication
(10) Pub. No.: US 2021/0225534 A1
(43) Pub. Date: Jul. 22, 2021

(54) Method for Ensuring Hydrogen Explosion Safety at Nuclear Power Plant

(71) Applicants: JOINT STOCK COMPANY "ROSENERGOATOM", Moscow (RU); JOINT STOCK COMPANY "SCIENCE AND INNOVATIONS", Moscow (RU)

(72) Inventors: Anatoliy Semenovich IVANOV, Chelyabinskaya oblast (RU); Vadim Aleksandrovich SIMONENKO, Chelyabinskaya oblast (RU); Ivan Vladimirovich LAVRENYUK, Chelyabinskaya oblast (RU); Nikolai Borisovich ANIKIN, Chelyabinskaya oblast (RU); Aleksandr Anatol'evich TYAKTEV, Chelyabinskaya oblast (RU); Viktor Nikolaevich FEDYUSHKIN, Chelyabinskaya oblast (RU); Il'ya Aleksandrovich POPOV, Chelyabinskaya oblast (RU); Evgeniy Vital'evich BEZGODOV, Chelyabinskaya oblast (RU); Sergey Dmitrievich PASYUKOV, Chelyabinskaya oblast (RU); Sergey Mikhailovich UL'YANOV, Chelyabinskaya oblast (RU); Aleksandr Valerievich PAVLENKO, Chelyabinskaya oblast (RU)

(21) Appl. No.: 16/306,437

(22) PCT Filed: Dec. 25, 2017
(86) PCT No.: PCT/RU2017/000966

§ 371 Date: Nov. 30, 2018

(30) Foreign Application Priority Data
Nov. 30, 2017 (RU) 2017141801

(51) Int. Cl. G21C 9/06; G21C 13/02; G21C 19/317

(52) U.S. Cl. CPC G21C 9/06; G21C 19/317; G21C 13/022

(57) ABSTRACT

Hydrogen explosion safety in premises of the containment dome (CNT) at nuclear power plants (NPP) with water-cooled power reactor (VVER). The method for ensuring hydrogen explosion safety at nuclear power plants comprises ventilation of premises of the nuclear reactor premises and hydrogen recombination in premises of the nuclear reactor premises by its catalytic oxidation. In accordance with the declared solution, a reflector is placed on the way of potentially emergency propagation of a pressure hydrogen-containing steam-gas jet, apertures are made in the walls between premises of the nuclear reactor containment dome with a size equal to minimum 35% of the surface area of the said walls, while excess heat is withdrawn in areas of potential localization of hydrogen-containing steam-gas mixture burning sources.

### CROSS-REFERENCE TO RELATED APPLICATIONS

This application is a US 371 Application from PCT/RU2017/000966 filed Dec. 25, 2017, which claims priority to Russia Application 2017141801 filed Nov. 30, 2017, the technical disclosures of which are hereby incorporated herein by reference.

### TECHNICAL FIELD

The invention relates to emergency protection of nuclear power plants, particularly to technologies for mitigation of consequences or fire prevention and prevention of explosive gas accumulation, which ensure hydrogen explosion safety in premises of the containment dome (hereinafter—CNT) at nuclear power plants (hereinafter—NPP) with water-cooled power reactor (hereinafter—VVER). Moreover, the offered invention can be used at other facilities having the risk of development of potentially hazardous emergency processes, related to the emission of a large amount of light combustible gas and its localization in closed premises of a facility.

### BACKGROUND OF THE INVENTION

A method is known for mitigating consequences of severe accidents, related to reduction of hydrogen amount in NPP CNT premises through localized catalytic oxidation of hydrogen inside a recombiner housing, described in RF Patent No. 2264853. The said technical solution reduces hazard by installing a certain quantity of passive catalytic hydrogen recombiners (hereinafter—PCHR) in premises of the nuclear power plant containment dome. With PCHR operating efficiency, the hydrogen-containing compound can either not inflame or may burn less intensively due to reduced hydrogen concentration. An additional positive factor is the medium mixing, localized in the recombiner's vicinity, which is caused by the outflow of hydrogen-poor hot gases from the recombiner top, which facilitates the reduction of hydrogen concentration in the area adjacent to the recombiner. A drawback of this technical solution is the risk of inflammation of hydrogen-containing steam-gas compounds, mixture or jet (hereinafter—HSGM) in the region, adjoining the recombiner, that may occur at sufficiently high hydrogen concentrations due to catalyst surface warming up to high temperatures because of intensive hydrogen oxidation reactions.

A method is known for mitigating consequences of severe accidents, described in RF Patent No. 2595639, performed by reducing the power load on containment dome structural elements, due to heat withdrawal from CNT premises, accompanied with reduction of temperature and pressure inside the premises. This, in turn, is accompanied with steam condensation on the walls of CNT premises. The dropping of condensed water under the force of gravity additionally agitates the mixture and facilitates reduction of stagnant regions with an increased hydrogen concentration. A drawback of the said technical solution is the increased risk of HSGM inflammation due to a reduced concentration of water vapor, being a phlegmatizing agent in the hydrogen combustion reaction.

A method is also known for preventing the inflammation and explosion of hydrogen-air mixtures, described in RF Patent No. 2081892, which consists in the addition or injection of inhibitors into hydrogen-air mixtures in order to narrow the region of hydrogen-air mixture inflammation. The drawbacks of the said method are as follows:

a small reduction of the inflammation area, i.e. inflammation event probability is not significantly reduced;

inhibitor supply and distribution systems need power supply, i.e. they are not passive components of the safety assurance complex, which makes this method unusable for a greater class of severe accidents with power loss;

the inhibitor is supplied, as a rule, at the initial stage of the accident due to the uncertainty of the burning start moment, thereat, the absence of a mechanism for ensuring uniform filling of CNT premises with inhibitor may cause its local accumulation in a CNT premise remote from the hydrogen inflow point, which does not affect the inflammation probability in any way;

not all inhibitors are neutral towards structural materials at NPP.

A method is known for passive inertisation of gas mixture in a nuclear power plant protective reservoir, described in RF Patent No. 2134917, which is devoid of some of the drawbacks of the previous patent. The method, implemented by means of a device for passive inertisation of gas mixture in the nuclear power plant protective reservoir, employs substances that start emitting carbon dioxide at heating of the atmosphere inside the containment dome or at PCHR heating after its operation start. Thus, the method is passive, while inhibitor is released throughout the course of accident. The drawbacks of this method are the risk of a chemical reaction between the released gas and the catalyst bed of PCHR, which may reduce PCHR performance or cause PCHR failure, as well as the insignificant narrowing of the area of hydrogen-air mixture inflammation limits, as compared to the inhibitors stated in the previous patent.

The closest analogue, chosen as a prototype, is the method described in RF Patent No. 2473993, which includes the termination or reduction of the rate of hydrogen burning in hydrogen-containing steam-gas mixture in case of its inflammation in containment dome premises through its recombination by means of a PCHR.

The drawbacks of this technical solution are as follows:

slow attainment of the rated capacity mode of the recombiner;

possible formation of stagnant zones with increased hydrogen concentration in overlying layers due to hydrogen inflow into the recombiner housing from underlying layers;

relatively high hydrogen concentrations create the risk of recombiner “acceleration” up to HSGM inflammation in its surroundings, followed by burning propagation across the CNT premises.

The task of the declared invention is the mitigation of hazardous consequences of severe accidents at NPP with VVER, such as explosion-like (fast) combustion or detonation processes of the gas medium in NPP CNT premises.

The technical result attained by the declared invention consists in the reduction of the risk of gas medium inflammation in premises of NPP CNT, as well as in the provision of self-damping of weak burning waves, reduction of their intensity in case of gas medium inflammation in premises of NPP CNT and in reduction of dynamic loads on walls of premises of NPP CNT.

The specified technical result is attained due to the fact that in the method for ensuring hydrogen explosion safety at nuclear power plants, comprising ventilation of premises of the nuclear reactor premises and hydrogen recombination in premises of the nuclear reactor premises by its catalytic oxidation, in accordance with the declared solution, a reflector is placed on the way of potentially emergency propagation of a pressure hydrogen-containing steam-gas jet, apertures are made in the walls between premises of the nuclear reactor containment dome with a size equal to minimum 35% of the surface area of the said walls, while excess heat is withdrawn in areas of potential localization of hydrogen-containing steam-gas mixture burning sources.

The nuclear reactor containment dome premises are chiefly ventilated when hydrogen content in premises exceeds 2%.

Thereat, a reflector on the way of potentially emergency propagation of a pressure hydrogen-containing steam-gas jet can be provided in the form of a waterproof and heatproof shield, overlapping the aperture between the premise walls in the shield installation location by 20 to 65% of the surface area of the said aperture.

Moreover, a reflector on the way of potentially emergency propagation of a pressure hydrogen-containing steam-gas jet can be provided in the form of a perforated waterproof and heatproof casing installed on nuclear reactor pipelines.

Excess heat in areas of potential localization of hydrogen-containing steam-gas mixture burning sources is chiefly withdrawn by lining the surfaces of equipment installed in containment dome premises, ceilings and upper portions of containment dome premise walls with a highly thermally conductive material to 30% of their height.

Also, apertures with a surface area of minimum 35% of the surface area of each wall, forming a flow-through space, are chiefly arranged in the upper portion of walls, which adjoins the ceiling, between premises of the nuclear reactor containment dome.

### BRIEF DESCRIPTION OF THE DRAWINGS

The declared invention is illustrated by the following graphic materials.

FIG. 1 schematically shows a variant of reflector placement in the steam generator premise.

FIG. 2 schematically shows a variant of reflector placement in the premise of a steam generator connected with the bubbler premise.

FIG. 3 schematically shows a perforated cylindrical casing intended for installation on a part of the nuclear reactor primary circuit.

FIG. 4 shows a layout of an experimental setup in a mockup without a reflector installed therein.

FIG. 5 shows a graph of gas concentration distribution over the mockup height in case of an experiment without a reflector.

FIG. 6 shows a layout of an experimental setup in a mockup with a reflector installed therein.

FIG. 7 shows the A-A section of a reflector installed in a mockup.

FIG. 8 shows a graph of gas concentration distribution over the mockup height in case of an experiment with a reflector.

FIG. 9 shows a layout of an experimental setup in a mockup with a partition overlapping the channel cross-section by 90%.

FIG. 10 shows a layout of an experimental setup in a mockup without a partition overlapping the channel cross-section.

FIG. 11 shows a layout of an experimental setup in a mockup with a partition overlapping the channel cross-section by 65%.

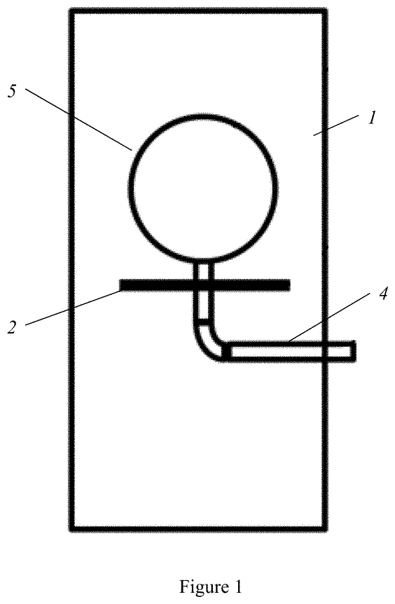

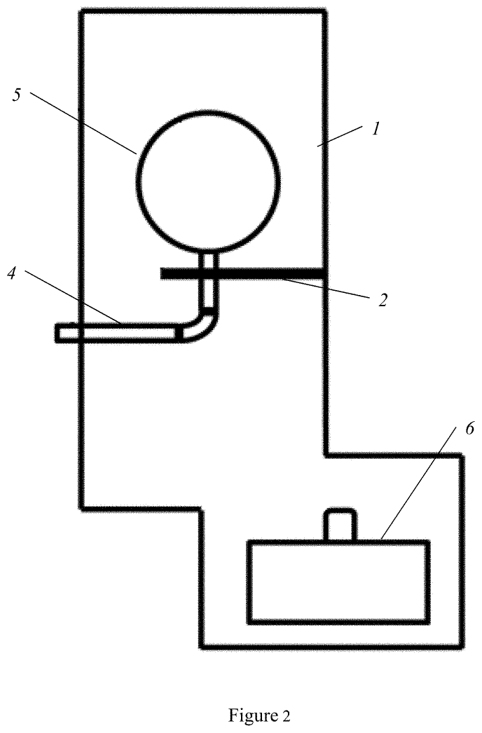

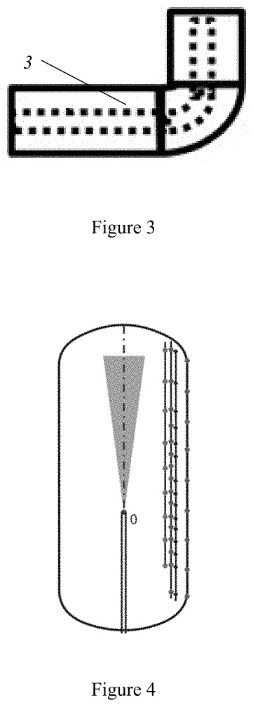

### DETAILED DESCRIPTION OF THE PREFERRED EMBODIMENTS

The suggested technical solution—a method fro ensuring hydrogen explosion safety at nuclear power plants—is explained by an example of an embodiment described below. The given example is not the only possible one, but it clearly demonstrates the possibility of achieving the declared technical result by the said combination of essential invention features.

A method for ensuring hydrogen explosion safety at nuclear power plants comprises the following actions.

Premises 1 of NPP CNT are ventilated when hydrogen consistence reaches 2%, thereat the said ventilation is emergency ventilation and may actuate at greater hydrogen contents, depending on conditions of inflammation of the HSGM present in premises.

Hydrogen in premises 1 of NPP CNT is recombined by catalytic oxidation in hydrogen recombiners (not shown in the figures), preliminarily installed in the containment dome premises, quantity of said recombiners being selected based on premise size.

Reflectors are placed in the way of potentially emergency propagation of a HSGM jet under pressure in premises 1 of NPP CNT; said reflectors can be waterproof and heatproof aluminum shields 2 and perforated casings 3. Shields 2 are placed so that they overlap the apertures between the walls of premises 1 of NPP CNT in their installation locations by 60% of the area of said apertures, while perforated casing 3 is installed on pipeline 4 of the nuclear reactor primary circuit. Thereat, the size of shield 2 can make up from 20 to 65% of the surface area of the aperture, formed by the walls of premise 1 of NPP CNT, whose smallest and largest size is selected based on the fact that, if shield 2 has a size less than 20% of the aperture surface area, the diameter of HSGM jet under pressure can be larger than the surface area of shield 2 in the contact point, which causes the penetration of a part of the jet into premise 1 of NPP CNT, located behind shield 2, without the necessary mixing with the surrounding air medium of premise 1 of NPP CNT, and HSGM concentration only in one part of premise 1 of NPP CNT. If shield 2 has a size over 65% of the aperture surface area, upon contact with a HSGM jet under pressure there occurs uniform mixing with the air medium of premise 1 of NPP CNT, and in case of HSGM inflammation in one part of premise 1 of NPP CNT and flame penetration into the other part of premise 1 of NPP CNT there can be turbulization of the flame flow passing through the aperture, formed by shield 2, which leads to significantly accelerated flame propagation.

Casing 3 is placed chiefly from the side of the open space near the pipeline, i.e. not from the side of the wall or the nearby pipeline, which results in efficient mixing of the delivery HSGM at its outflow from the pipeline with the air medium in premise 1 of NPP CNT.

Apertures are made in the walls between premises 1 of NPP CNT with a size equal to 40% of the surface area of said walls, thereat said apertures in the upper part of the walls between premises 1 of NPP CNT, which adjoins the ceiling, are made with formation of a flow-through space, i.e. at the ceiling level of premises 1 of NPP CNT the above-aperture part of the wall is missing and the ceilings of premises 1 of NPP CNT have no obstacles for HSGM flow-over from one premise 1 of NPP CNT to another. Thereat, apertures in walls between premises 1 of NPP CNT can take from 35% and more of the surface area of these walls. The smallest aperture size is selected based on the fact that, in case of HSGM inflammation in one premise 1 of NPP CNT and flame penetration into another premise 1, there can be turbulization of the flame flow passing through the aperture in the wall of premise 1 of NPP CNT, leading to significantly accelerated flame propagation, while the largest size is selected based on design need.

Excess heat in areas of potential localization of HSGM burning sources is withdrawn by lining the surfaces of equipment installed in premises 1 of NPP CNT—steam generator 5 and bubbler 6, as well as ceilings and upper portions of the walls of premises 1 of NPP CNT to 30% of their height with a highly thermally conductive material, for instance aluminum.

Hydrogen explosion safety of nuclear power plants according to the said method is ensured as follows.

In case of a severe accident, related to HSGM outflow in premises 1 of NPP CNT, ventilation and hydrogen recombination are simultaneously performed when the 2% hydrogen content is reached. The said actions aim to reduce hydrogen content in premises 1 of NPP CNT.

When a HSGM jet under pressure flows out in premise 1 of NPP CNT, aluminum shield 2, installed on its way, facilitates the uniform mixing of HSGM in premise 1 of NPP CNT, thus preventing HSGM localization in a single area of premise 1 of NPP CNT. Also, in case of HSGM jet under pressure outflow in premise 1 of NPP CNT from pipeline 4 of the nuclear reactor primary circuit, whereon perforated casing 3 is installed, the latter also facilitates the HSGM mixing in premise 1 of NPP CNT, thus ensuring a multitude of differently directed perforations of HSGM jets in the vicinity of pipeline 4 of the nuclear reactor primary circuit. Thus, the uniform mixing of HSGM in premises 1 of NPP CNT facilitates improved hydrogen recombination due to the involvement of all hydrogen recombiners installed in premises 1 of NPP CNT. If there is no mixing of the steam-hydrogen mixture in premises 1 of NPP CNT, mainly the recombiners located in the areas of steam-hydrogen mixture localization are involved. The uniform mixing of HSGM, preventing its localization in one area of premise 1, prevents HSGM inflammation.

Moreover, in case of outflow of a HSGM jet under pressure in premise 1 of NPP CNT, the apertures (forming a flow-through space) in the upper portion of walls, which adjoins the ceiling, between premises 1 of NPP CNT facilitate the flow-over of HSGM from one premise 1 of NPP CNT to another, thus reducing the HSGM concentration in the premise where outflow is taking place, and allows for activating the ventilation and recombiners located in other premises 1 of NPP CNT.

In case of ignition of HSGM in one or several premises 1 of the nuclear reactor containment dome, the apertures in their walls, size whereof is equal to 40% of the surface area of said walls, prevent turbulization of the burning flow passing through the said apertures, thus reducing the speed of burning HSGM propagation.

Also, in case of ignition of HSGM in one or several premises 1 of NPP CNT, the burning flow of flame floats up from the bottom portions of premises 1 of NPP CNT to the upper ones (areas of potential localization of HSGM burning sources), due to the fact that hydrogen concentration is higher in the upper portions of premises 1 of NPP CNT. In the upper portions of premises 1 of NPP CNT, which comprise the equipment—steam generators 5 and bubblers 6, ceilings and upper portions of the walls of premises 1 of NPP CNT to 30% of their height, excess heat is withdrawn by lining the surfaces of the said portions with a highly thermally conductive metal, which is aluminum. Heat transfer by the HSGM burning source to the surface, line with a highly thermally conductive metal, facilitates the dying-out of the HSGM burning source or reduction of its rate, thus preventing further inflammation of HSGM in other parts of premise 1 of NPP CNT or the passing of HSGM burning to other premises 1 of NPP CNT. Thereat, aluminum shields 2 installed in premise 1 of NPP CNT and perforated aluminum casings 3, installed on pipeline 4 of the nuclear reactor primary circuit, receive the heat from the HSGM burning sources, which also facilitates the dying-out of the HSGM burning source or reduction of burning rate and prevents further HSGM inflammation in other parts of premise 1 of NPP CNT or the passing of HSGM burning into other premises 1 of NPP CNT.

Efficiency of the suggested method for ensuring hydrogen explosion safety at nuclear power plants has been experimentally confirmed on mockups. Experimental data were obtained on the inflammation limits for HSGM at the pressures and temperatures, typical for severe accidents, as well as data on development and change of HSGM combustion conditions in mockups of NPP CNT premises in case of HSGM jet outflows, typical for severe accidents at NPP with VVER.

### Example 1

The experiment used a mockup in the form of chamber 7 (FIG. 4), having the height of 5 m, diameter of 2 m, working volume of 14.6 m³. The chamber was preheated to 110° C., it was filled with air at atmospheric pressure. The said chamber was supplied with a mixture corresponding to the design HSGM at its outflow in NPP CNT premises in case of severe accidents, while the average content of hydrogen-steam-air components of HSGM matched the following percentages: 10-34-56 respectively. Gases were supplied from point O shown in FIG. 4, located at the height of 3.14 m from the bottom point of the chamber volume.

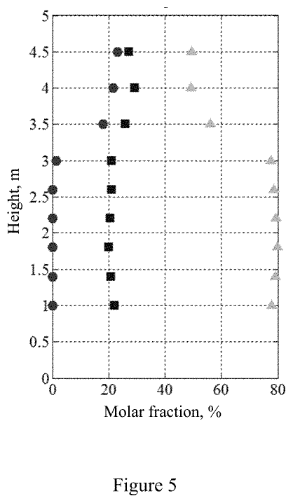

Upon completion of HSGM supply by means of gas analyzers (not shown in the figures), installed with an interval of 0.5 m over the chamber height, the contents of hydrogen-steam-air components of HSGM were measured. The experiment results are shown in FIG. 5 as a point diagram, with round markers designating hydrogen, square markers designating steam, and triangular markers designating air. Thus, the diagram shows that the distribution of hydrogen-steam-air components of HSGM over the chamber height is not uniform, in particular, the largest hydrogen concentration was recorded starting from the point of HSGM supply from point O and up to the dome of chamber 7.

After the obtained HSGM stabilized, it was inflamed by means of a spark element (not shown in the figure) at the height of 3.5 m, which resulted in floating-up of the burning thermal flow to the dome of chamber 7, while burning rate and pressure on the walls of chamber 7 increased. The burning died out only after hydrogen combustion in the HSGM, which was localized in the upper portion of chamber 7 under the dome, while the heat emitted during burning facilitated the continuation of burning.

### Example 2

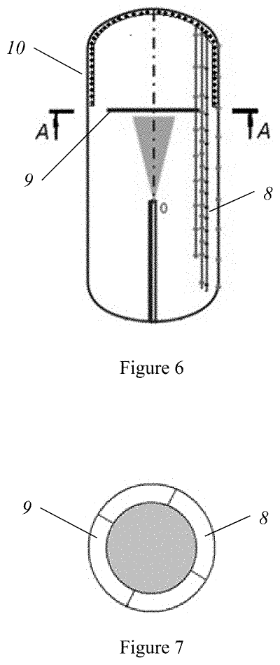

The experimental setup corresponds to the description of the experiment in example 1, and differs from it in that at the height of 3.4 m from the bottom point of the volume of chamber 8 (FIG. 6) a flat reflector was additionally installed in the form of shield 9 (FIG. 6 and FIG. 7), overlapping the chamber cross-section by 65%. Thereat, the upper portion of the inner surface of chamber 8 below the dome and about 30% of walls from the dome over the height was lined with highly thermally conductive metal 10. Aluminum was used as a lining highly thermally conductive metal in the experimental model.

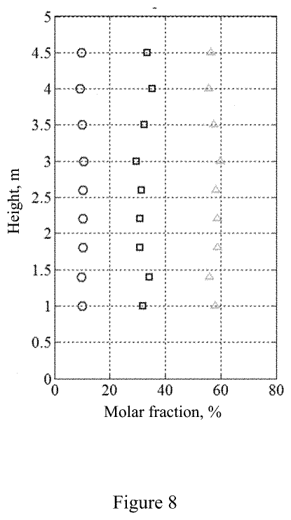

In this experimental setup the supplied HSGM contacted shield 9, thus ensuring more uniform mixing of HSGM with the air medium of chamber 8 and uniform distribution of HSGM components. The results of measuring the content of hydrogen-steam-air components of HSGM over the height of chamber 8, obtained by means of gas analyzers, are shown in FIG. 8, where on the presented point diagram the round markers designate hydrogen, square markers designate steam, and triangular markers designate air.

Upon completion of gas supply and HSGM stabilization, the mixture was inflamed by means of a spark element (not shown in the figure) at the height of 3.5 m. Gas concentration distribution at the moment of inflaming was more uniform than during the experiment described in example 1, and corresponding to the ratio of hydrogen-steam-air components of HSGM: 10-34-56 respectively.

The visualization procedure was used to record the floating-up of the flame focus and its localization under the dome of chamber 8. Thereat, the flame source transferred the heat to the surface of the dome of chamber 8, lined with highly thermally conductive metal 10, after which the burning source temperature decreased and its hydrogen concentration decreased (due to burning), which jointly made the flame die out. After the flame died out, a repeated localization of hydrogen in HSGM in the upper portion of the dome of chamber 8 took place, which was ensured by the movement of hydrogen-rich HSGM from the bottom portion of chamber 8 to the upper one. Then the burning was initiated again, which was stopped by the aforesaid method. The cycle of burning initiation and dying-out was repeated until hydrogen concentration in HSGM decreased to a concentration not inflammable by means of the spark element.

### Example 3

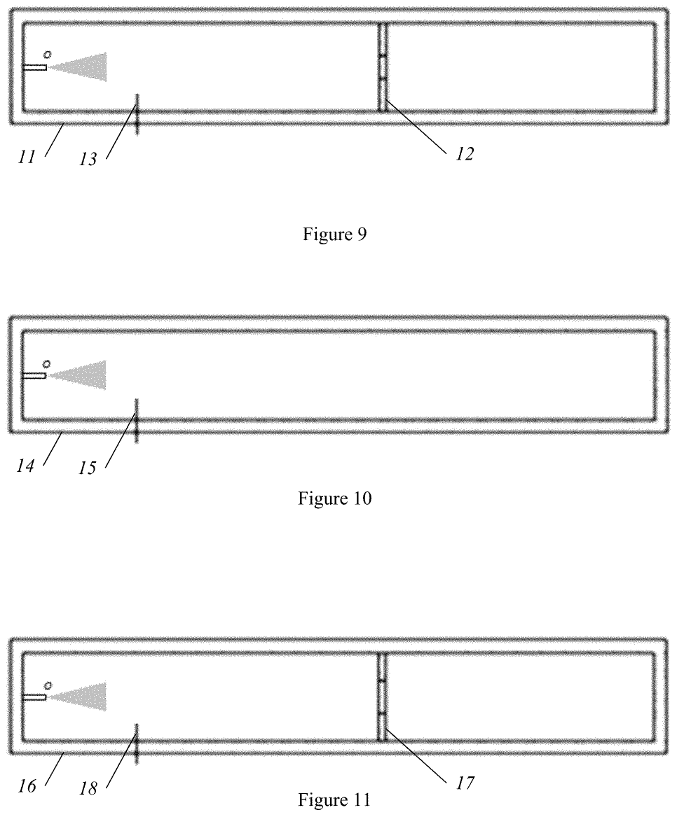

The experiment used a mockup in the form of chamber 11 (FIG. 9), having a square section with the side of 138 mm and length of about 1.5 m. Partition 12, overlapping the channel cross-section by 90%, was placed in chamber 11. The said chamber was supplied with a mixture corresponding to the design HSGM at its outflow in NPP CNT premises in case of severe accidents, while the average content of hydrogen-steam-air matched the following percentages: 10-34-56 respectively. Gases were supplied from point O (FIG. 9

When the obtained HSGM stabilized, it was inflamed by means of spark element 13. The visualization procedure has recorded that the flame front displaced the unburnt mixture through partition 12, making it turbulent, thus increasing the dynamic loads in 3 times. When the flame approached partition 12, the burning intensified abruptly and the flame flow quickly went over to the other part of chamber 11, separated by partition 12.

### Example 4

The experimental setup corresponds to the description of the experiment in example 3, and differs from it in that a partition, overlapping the channel cross-sections, was not placed in chamber 14. To chamber 14 (FIG. 10) HSGM shown at example 3 has been placed. Gases were supplied from point O (FIG. 10).

When the obtained HSGM stabilized, it was inflamed by means of spark element 15. The visualization procedure has recorded that the flame front propagated with a constant speed, did not become turbulent, and the burning did not intensify abruptly.

### Example 5

The experimental setup corresponds to the description of the experiment in example 3, and differs from it in that partition 17 was placed in chamber 16, overlapping the channel cross-section by 65%. To chamber 16 (FIG. 11) HSGM shown at example 3 has been placed. Gases were supplied from point O (FIG. 11).

When the obtained HSGM stabilized, it was inflamed by means of spark element 18. The visualization procedure has recorded that the flame front displaced the unburnt mixture through partition 17, while increase of dynamic loads was only 1.4 times greater than the value recorded in the experiment of example 4. Thereat, when the flame approached partition 17, the burning did not intensify abruptly, while the flame flow went over to the other part of chamber 16, separated by partition 17, without acceleration.

For the declared invention as it is characterized in the claims, feasibility of the method for ensuring hydrogen explosion safety at nuclear power plants and the possibility to attain the specified technical result were confirmed.

1. A method for ensuring hydrogen explosion safety at nuclear power plants, comprising ventilation of premises of the nuclear reactor premises and hydrogen recombination in premises of the nuclear reactor premises by its catalytic oxidation, characterized in that a reflector is placed on the way of potentially emergency propagation of a pressure hydrogen-containing steam-gas jet, apertures are made in the walls between premises of the nuclear reactor containment dome with a size equal to minimum 35% of the surface area of the said walls, while excess heat is withdrawn in areas of potential localization of hydrogen-containing steam-gas mixture burning sources.

2. A method under claim 1, characterized in that nuclear reactor containment dome premises are ventilated when hydrogen content in premises exceeds 2%.

3. A method under claim 1, characterized in that a reflector on the way of potentially emergency propagation of a pressure hydrogen-containing steam-gas jet is provided in the form of a waterproof and heatproof shield, overlapping the aperture between the premise walls in the shield installation location by 20 to 65% of the surface area of the said aperture.

4. A method under claim 1, characterized in that a reflector on the way of potentially emergency propagation of a pressure hydrogen-containing steam-gas jet is provided in the form of a perforated waterproof and heatproof casing installed on nuclear reactor pipelines.

5. A method under claim 1, characterized in that excess heat in areas of potential localization of hydrogen-containing steam-gas mixture burning sources is withdrawn by lining the surfaces of equipment installed in containment dome premises, ceilings and upper portions of containment dome premise walls with a highly thermally conductive material to 30% of their height.

6. A method under claim 1, characterized in that apertures with a surface area of minimum 35% of the surface area of each wall, forming a flow-through space, are arranged in the upper portion of walls, which adjoins the ceiling, between premises of the nuclear reactor containment dome.
